(19) United States
(12) Patent Application Publication
(10) Pub. No.: US 2021/0348828 A1
(43) Pub. Date: Nov. 11, 2021

(54) REFRIGERATOR AND METHOD OF CONTROLLING THE SAME

(71) Applicant: SAMSUNG ELECTRONICS CO., LTD., Suwon-si, Gyeonggi-do (KR)

(72) Inventors: Hyun Jae SHIN, Suwon-si (KR); Suk Won CHOI, Suwon-si (KR); Yang-Don LEE, Suwon-si (KR); Sun Hyung KIM, Suwon-si (KR); Sanjeev BA, Suwon-si (KR); Kyung Il LEE, Suwon-si (KR)

(73) Assignee: SAMSUNG ELECTRONICS CO., LTD., Suwon-si, Gyeonggi-do (KR)

(21) Appl. No.: 17/278,057

(22) PCT Filed: Sep. 20, 2019
(86) PCT No.: PCT/KR2019/012286

§ 371 Date: Mar. 19, 2021

(30) Foreign Application Priority Data
Sep. 21, 2018 (KR) 10-2018-0113475

(51) Int. Cl. F25D 23/02; F25D 29/00

(52) U.S. Cl. CPC F25D 23/028; F25D 2327/00; F25D 2400/361; F25D 29/005

(57) ABSTRACT

An aspect of the present disclosure is to provide a refrigerator and a method of controlling the same that protects privacy by designating a user in each storage chamber and allowing only the designated user to use the storage chamber in order to protect the privacy of each user and preventing mishandling of items stored in the refrigerator in advance when the plurality of users share a refrigerator, and prevents mishandling of stored items by prohibiting the use of the storage chamber other than the designated storage chamber. The refrigerator includes a display; a storage chamber configured to allow use only by authorized users; and a controller configured to display information of the storage chamber through the display in response to the completion of user authentication of the storage chamber.

### TECHNICAL FIELD

The present disclosure relates to a refrigerator.

### BACKGROUND ART

A refrigerator has a storage chamber divided into a plurality of areas. The refrigerator may be used alone by one person or shared by a plurality of users. For example, one refrigerator in a home is shared by several family members. As another example, several members share the refrigerator in a dormitory in a school or a bath room in a workplace.

In this way, when the plurality of users share one refrigerator, the privacy of each user may not be maintained. When storing medicines in the refrigerator, problems may arise because children, etc. handle them incorrectly.

### DISCLOSURE

### Technical Problem

An aspect of the present disclosure is to provide a refrigerator that protects privacy by designating a user in each storage chamber and allowing only the designated user to use the storage chamber in order to protect the privacy of each user and preventing mishandling of items stored in the refrigerator in advance when the plurality of users share a refrigerator, and prevents mishandling of stored items by prohibiting the use of the storage chamber other than the designated storage chamber.

### Technical Solution

An aspect of the disclosure provides a refrigerator including: a display; a storage chamber configured to allow use only by authorized users; and a controller configured to display information of the storage chamber through the display in response to the completion of user authentication of the storage chamber.

The display may be provided in the storage chamber.

The display may include a plurality of Light Emitting Diodes (LEDs), and is configured to display information of the storage chamber through lighting of the plurality of LEDs.

The information of the storage chamber may be configured to distinguish the designated user by lighting the plurality of LEDs in a combination of a plurality of colors.

The display may include at least one liquid crystal display (LCD) device, and is configured to display information of the storage chamber through the at least one LCD device.

The information of the storage chamber may include a limit period of use of the storage chamber.

The information of the storage chamber may include the number of times the storage chamber can be used.

The refrigerator may further include a door provided to open and close the storage chamber. The display may be provided on the door.

The information of the storage chamber displayed on the display may include position information of the storage chamber and storage item information of the storage chamber.

The information of the storage chamber displayed on the display may include a set temperature of the storage chamber.

A user interface for allowing an authenticated user to change the set temperature of the storage chamber may be configured to display on the display.

A surface exposed to the outside of the storage chamber may be formed of variable transmittance glass.

By adjusting the transmittance of the variable transmittance glass, only the authorized user of the storage chamber may see the inside of the storage chamber.

The storage chamber is composed of a plurality of storage chambers; the display is provided in each of the plurality of storage chambers; and the display of each of the plurality of storage chambers is configured to display user information of each of the plurality of storage chambers.

The user information may include a name of the user designated to each of the plurality of storage chambers.

The user information may further a name of a user group to which the user designated to each of the plurality of storage chambers belongs.

Another aspect of the disclosure provides a refrigerator including: a display; a storage chamber configured to allow use only by authorized users, and in which a surface exposed to the outside is formed of a variable transmittance glass; and a controller configured to display information of the storage chamber through the display in response to the completion of user authentication of the storage chamber.

By adjusting the transmittance of the variable transmittance glass, only the authorized user of the storage chamber may see the inside of the storage chamber.

Another aspect of the disclosure provides a refrigerator including: a display; a storage chamber configured to allow use only by authorized users; and a controller configured to display information for identifying the designated user of the storage chamber through the display in response to the completion of user authentication of the storage chamber.

The display may be a plurality of LEDs provided in the storage chamber.

The plurality of LEDs are lit by a combination of a plurality of colors to distinguish the designated user.

Another aspect of the disclosure provides a refrigerator including: a storage chamber configured to allow use only by authorized users; and a display provided in each of the plurality of storage chambers. Designated user information of each of the plurality of storage chambers may be displayed on the display of each of the plurality of storage chambers.

The user information may further a name of a user group to which the user designated to each of the plurality of storage chambers belongs.

Another aspect of the disclosure provides a method of controlling a refrigerator, the refrigerator includes a display, a user authentication device provided to perform user registration and authentication, and a storage chamber configured to allow use only by authorized users. The method of controlling the refrigerator including: designating and authenticating a user for the storage chamber through the user authentication device; and displaying information of the storage chamber through the display in response to the completion of user authentication of the storage chamber.

The display may include a plurality of LEDs provided in the storage chamber. The information of the storage chamber may be configured to distinguish the designated user by lighting the plurality of LEDs in a combination of a plurality of colors.

The display may include at least one LCD device. At least one of a limiting period of use of the storage chamber and a number of times of the storage chamber can be used is displayed through the at least one LCD device.

The position information of the storage chamber and information of storage items of the storage chamber may be displayed through the at least one LCD device.

The set temperature of the storage chamber may be displayed through the at least one LCD device.

A user interface for allowing the authenticated user to change the set temperature of the storage chamber may be displayed on the display.

### Advantageous Effects

According to an embodiment, when a plurality of users share the refrigerator, in order to protect the privacy of each user and preventing mishandling of items stored in the refrigerator in advance, by designating the user in each storage chamber and allowing only the designated user to use the storage chamber, the privacy may be protected, and the use of the storage chamber other than the designated storage chamber is prohibited to prevent mishandling of stored items.

### DESCRIPTION OF DRAWINGS

FIG. 1 is a view illustrating a front of a refrigerator according to an embodiment.

FIG. 2 is a view illustrating a storage chamber of a refrigerator according to an embodiment.

FIG. 3 is a view illustrating a control system of a refrigerator according to an embodiment.

FIG. 4 is a view illustrating an example in which a refrigerator communicates with external devices according to an embodiment.

FIG. 5 is a view illustrating an appearance of a user device communicating with a refrigerator according to an embodiment.

FIG. 6 is a view illustrating a control system of the user device illustrated in FIG. 5.

FIG. 7 is a view illustrating user registration of a refrigerator according to an embodiment.

FIG. 8 is a view illustrating a locking device of a storage chamber of a refrigerator according to an embodiment.

FIG. 9 is a view illustrating another embodiment of a user authentication device of a refrigerator according to an embodiment.

FIG. 10 is a view illustrating an example of a display provided in a storage chamber of a refrigerator according to an embodiment.

FIG. 11 is a view illustrating an example of displaying storage chamber information of a refrigerator according to an embodiment.

FIG. 12 is a view illustrating another example of a storage chamber of a refrigerator according to an embodiment.

FIG. 13 is a view illustrating another example of displaying storage chamber information according to user authentication of a refrigerator according to an embodiment.

FIG. 14 is a view illustrating a refrigerator according to another embodiment.

FIG. 15 is a view illustrating another example of displaying storage chamber information of a refrigerator according to an embodiment.

### MODES OF THE INVENTION

Like reference numerals refer to like elements throughout the specification. Not all elements of the embodiments of the disclosure will be described, and the description of what are commonly known in the art or what overlap each other in the exemplary embodiments will be omitted. The terms as used throughout the specification, such as “˜ part,” “˜ module,” “˜ member,” “˜ block,” etc., may be implemented in software and/or hardware, and a plurality of “˜ parts,” “˜ modules,” “˜ members,” or “˜ blocks” may be implemented in a single element, or a single “˜ part,” “˜ module,” “˜ member,” or “˜ block” may include a plurality of elements.

It will be further understood that the term “connect” and its derivatives refer both to direct and indirect connection, and the indirect connection includes a connection over a wireless communication network.

The terms “include (or including)” and “comprise (or comprising)” are inclusive or open-ended and do not exclude additional, unrecited elements or method steps, unless otherwise mentioned. It will be further understood that the term “member” and its derivatives refer both to when a member is in contact with another member and when another member exists between the two members.

Further, when it is stated that a layer is “on” another layer or substrate, the layer may be directly on another layer or substrate or a third layer may be disposed therebetween.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section.

It is to be understood that the singular forms “a,” “an,” and “the” include plural references unless the context clearly dictates otherwise.

Reference numerals used for method steps are merely used for convenience of explanation, but not to limit an order of the steps. Thus, unless the context clearly dictates otherwise, the written order may be practiced otherwise.

Hereinafter, an operation principle and embodiments of the disclosure will be described with reference to accompanying drawings.

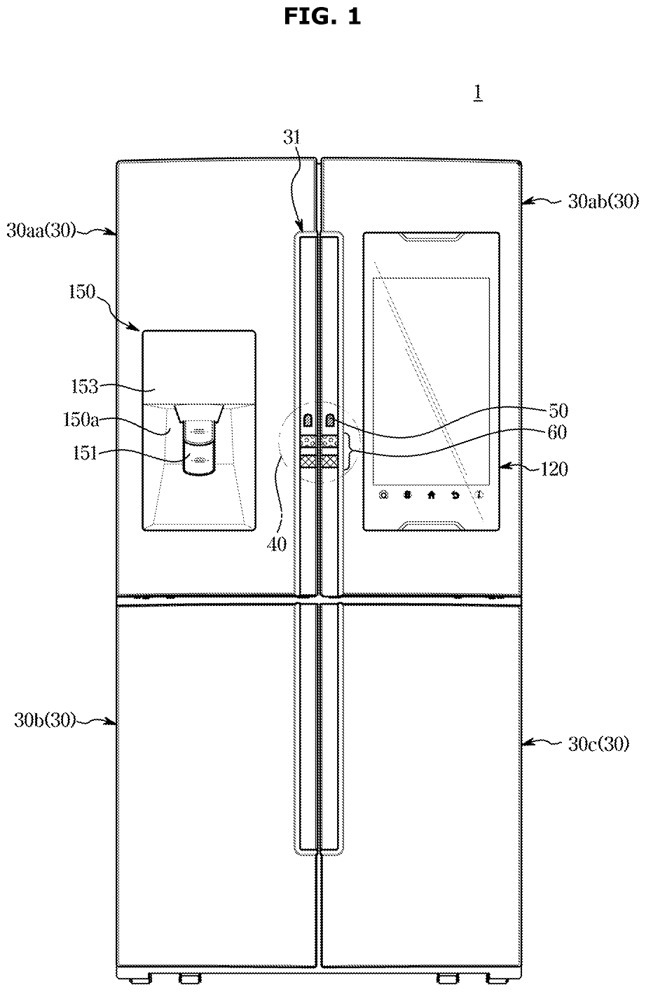

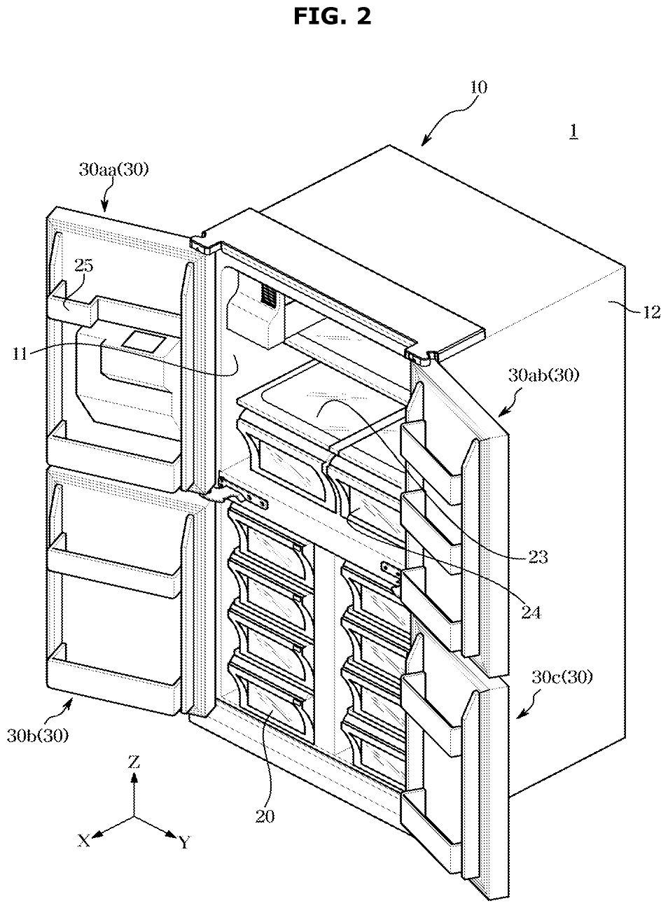

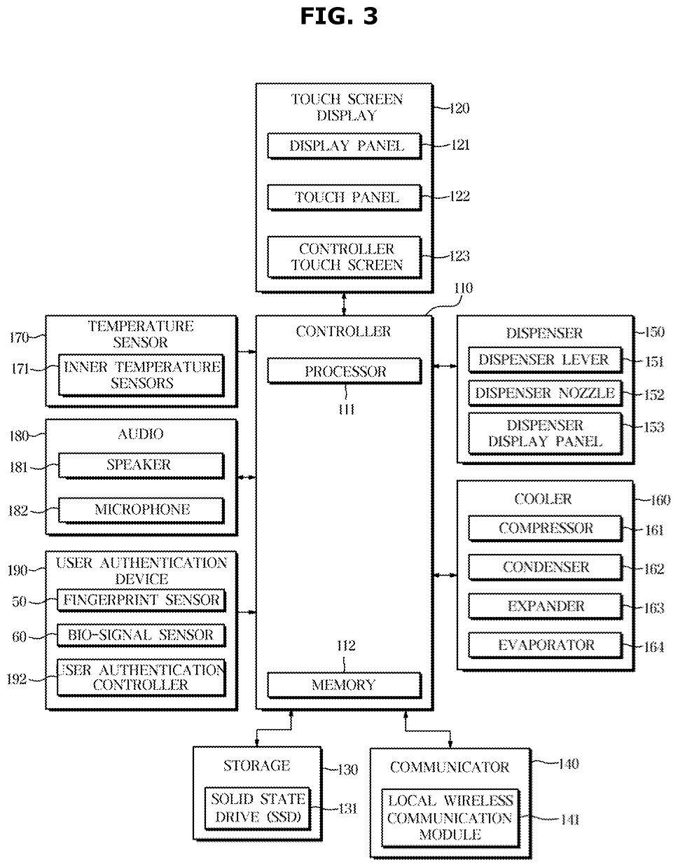

FIG. 1 is a view illustrating a front of a refrigerator according to an embodiment. FIG. 2 is a view illustrating a storage chamber of a refrigerator according to an embodiment. FIG. 3 is a view illustrating a control system of a refrigerator according to an embodiment.

Referring to FIGS. 1 to 3, a refrigerator 1 may include a main body 10 whose front surface opens, a storage chamber 20 formed in the inside of the main body 10 and configured to refrigerate and/or freeze food, and a door 30 configured to open or close the opened front surface of the main body 10.

The main body 10 may form an appearance of the refrigerator 1. The main body 10 may include an inner casing 11 to form the storage chamber 20, and an outer casing 12 coupled to an exterior of the inner casing 11. An insulator may be formed between the inner casing 11 and the outer casing 12 of the main body 10 so as to prevent leakage of cool air from the storage chamber 20.

The storage chamber 20 may be divided into a plurality of chambers by a horizontal partition 21 and a vertical partition 22. For example, as illustrated in FIG. 1, the storage chamber 20 may be divided into an upper storage chamber 20a, a first lower storage chamber 20b, and a second lower storage chamber 20c. The storage chamber 20 may be provided with a shelf 23 on which food can be placed, and an airtight container 24 for storing food.

The storage chamber 20 may be opened or closed by the door 30. For example, as illustrated in FIG. 1, the upper storage chamber 20a may be opened or closed by a first upper door 30aa and a second upper door 30ab. The first lower storage chamber 20b may be opened and closed by a first lower door 30b, and the second lower storage chamber 20c may be opened and closed by a second lower door 30c.

A handle 31 may be provided on the door 30 to enable a user to easily open or close the door 30. A handle 31a may be extended longitudinally along and between the first upper door 30aa and the second upper door 30ab.

A fingerprint sensor 50 and a bio-signal sensor 60 are provided at a portion 40 of the handle 31 of the door 30 suitable for the user to grip. The fingerprint sensor 50 is for scanning a fingerprint of a user's thumb, but may scan fingerprints of the remaining four fingers excluding the thumb. The bio-signal sensor 60 may be for measuring the user's bio-signal including at least one of blood pressure, blood flow, heart rate, body temperature, body fat percentage, and weight.

In FIG. 1, the handle 31 is in a shape of an elongated rod, and when the user grips the handle 31, the user's thumb presses the handle 31, and the remaining four fingers and palms surround the outer peripheral surface of the handle 31. The fingerprint sensor 50 and the bio-signal sensor 60 are arranged according to the shape of the gripped hand. The fingerprint sensor 50 may be disposed in a place capable of recognizing the fingerprint of the thumb, and the bio-signal sensor 60 may be disposed in a place capable of conducting a current and measuring a voltage along a user's palm. In addition, the fingerprint sensor 50 and the bio-signal sensor 60 may be disposed within a distance that an adult user of ordinary physique can cover all with one hand.

The fingerprint sensor 50 and the bio-signal sensor 60 are devices for user registration and authentication. In an embodiment of the present disclosure, the user may be designated for each of the plurality of storage chambers 20 provided in the refrigerator 1, and the use of the designated storage chamber 20 is allowed only through authentication of the designated user. Therefore, the user may access the storage chamber 20 designated to him after passing user authentication.

As described above, by allowing only the designated user access to each storage chamber 20 in the refrigerator 1 according to the embodiment of the present disclosure, it is possible to protect the privacy of each of a plurality of users, facilitate storage of medicines, etc. that need to limit access to children, and prevent misuse and abuse of food.

As illustrated in FIG. 3, the refrigerator 1 may include a touch screen display 120, a storage 130, a communicator 140, a dispenser 150, and a cooler 160, a temperature sensor 170, an audio 180, a user authentication device 190, and a controller 110.

The touch screen display 120 may include a display panel 121 for displaying images, a touch panel 122 for receiving touch inputs, and a touch screen controller 123 for driving/controlling the display panel 121 and the touch panel 122.

The display panel 121 may convert image data received from the controller 110 through the touch screen controller 123 into an optical signal that the user can see.

The display panel 121 may employ a Cathode Ray Tube (CRT) display panel, a Liquid Crystal Display (LCD) panel, a Light Emitting Diode (LED) panel, an Organic Light Emitting Diode (OLED) panel, a micro Light Emitting Diode (uLED) panel, a Plasma Display Panel (PDP), or the like. The display panel 121 is not, however, limited thereto, but may employ other various displays capable of visually presenting an optical image corresponding to the image data.

The touch panel 122 may receive the user's touch input, and output an electric signal corresponding to the received touch input to the touch screen controller 123.

For example, the touch panel 122 may detect the user's touch on the touch panel 122 from a change in electrical resistance or capacitance, and output an electric signal corresponding to a coordinate of a point of the user's touch to the touch screen controller 123. The touch screen controller 123 may identify the coordinate of the point of the user's touch based on an electric signal received from the touch panel 122. Furthermore, the touch screen controller 123 may identify an input from the user based on the coordinate of the point of the user's touch.

The touch panel 122 may be arranged on the front of the display panel 121. In other words, the touch panel 122 may be arranged on a plane in which an image is displayed. Hence, the touch panel 122 may be formed of a transparent material to prevent distortion of an image displayed on the display panel 121.

The touch panel 122 may employ a resistive touch panel or a capacitive touch panel. It is not, however, limited thereto, and the touch panel 122 may employ other various touch panels capable of detecting the user's touch or proximity and outputting an electric signal corresponding to a coordinate of a point of the detected touch or proximity.

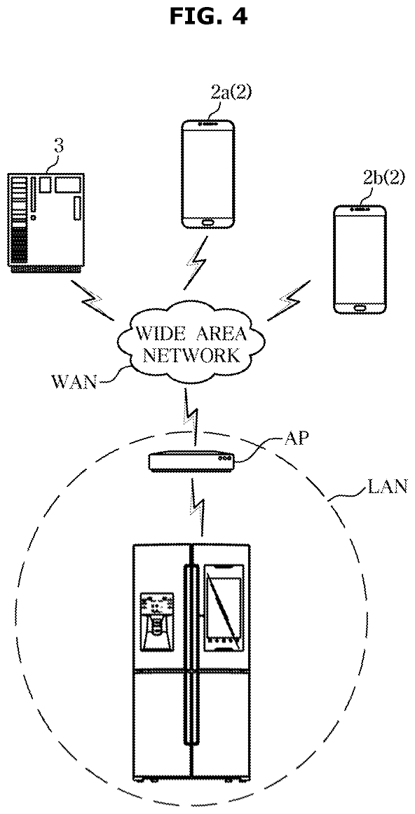

The touch screen controller 123 may control the operation of the display panel 121 and the touch panel 122. For example, as illustrated in FIG. 4, the touch screen controller 123 may control the touch panel 122 to detect the coordinates of the user's touch point, and control the display panel 121 to display an optical image corresponding to the image data received from the controller 110.

According to the embodiment, the touch screen controller 123 may determine coordinates of the user's touch point based on the electric signal output from the touch panel 122 and output the coordinates of the user's touch point to the controller 110. In addition, according to the embodiment, the touch screen controller 123 may transmit the electric signal output from the touch panel 122 to the controller 110 so that the controller 110 determines the coordinates of the user's touch point.

The touch screen controller 123 may include a memory for storing programs and data for controlling the operation of the display panel 121 and the touch panel 122, and a microprocessor that performs an operation to control operations of the display panel 121 and the touch panel according to programs and data stored in the memory. The memory and the processor of the touch screen controller 123 may be provided as separate chips or may be provided as a single chip.

The touch screen display 120 may then receive the touch input from the user and forward it to the touch screen controller 123, and display an image from the touch screen controller 123 that responds to the touch input from the user. That is, the touch screen display 120 may interact with the user.

The touch screen display 120 may be built in the door 30 for convenience of the user. For example, as illustrated in FIG. 2, the touch screen display 120 may be installed on the second upper door 30ab. In the following description, the touch screen display 120 installed on the second upper door 30ab will be focused, but it may not be limited thereto. For example, the touch screen display 120 may be installed anywhere viewable to the user, such as on the first upper door 30aa, on the first lower door 30b, on the second lower door 30c, and on the outer case 12 of the main body 10.

The touch screen display 120 may have a wakeup function that is automatically activated when the user approaches within a certain range. For example, when the user approaches within a certain range, the touch screen display 120 may be activated. In other words, the touch screen display 120 may be turned on. Furthermore, when a certain time elapses after the user gets out of the certain range, the touch screen display 120 may be deactivated. In other words, the touch screen display 120 may be turned off.

The touch screen display 120 may display various screens or images. The screen or image displayed on the touch screen display 120 will be described in detail below.

The storage 130 may include a non-volatile memory that stores a program or power and does not lose the stored program or data even when the power is cut off. For example, the storage 130 may include a large-capacity flash memory or a Solid State Drive (SSD) 131.

The storage 130 may store control programs and control data for controlling the operations of the refrigerator 1 and various application programs and application data that perform various functions according to the user input. For example, the storage 130 may include an operating system (OS) program that manages the configuration and resources (software and hardware) included in the refrigerator 1, an album application that displays images, user management applications for user registration and authentication, storage chamber designation and management for each user.

The storage 130 may provide programs and data to the controller 110 according to a storage control signal from the controller 110 or may store data output from the controller 110.

The communicator 140 may exchange data with the external device according to a communication control signal of the controller 110. For example, the communicator 140 may include a local wireless communication module 141.

The local wireless communication module 141 may wirelessly exchange data with the external device located at a relatively close distance. The local wireless communication module 141 may communicate with the external device using, for example, a communication standard such as Wireless Fidelity (WiFi), Bluetooth, and Zigbee.

The local wireless communication module 141 may include an antenna for transmitting a wireless signal to a free space or receiving the wireless signal from the free space, a modulator/demodulator for modulating data to be transmitted or demodulating the received wireless signal.

The dispenser 150 may discharge water or ice according to the user input. In other words, the user may directly take out water or ice to the outside without opening the door 30 through the dispenser 150.

The dispenser 150 may include a dispenser lever 151 for receiving a user's dispensing command, a dispenser nozzle 152 for discharging water or ice, and a dispenser display panel 153 for displaying an operating state of the dispenser 150.

The dispenser 150 may be installed outside the door 30 or the main body 10. For example, as illustrated in FIG. 2, the dispenser 150 may be installed on the first upper door 30aa. Hereinafter, the dispenser 150 installed in the first upper door 30a is described, but the dispenser 150 is not limited to being installed in the first upper door 30aa. The dispenser 150 may be installer anywhere, such as the second upper door 30ab, the first lower door 30b, the second lower 30c, and the outer casing 12 of the main body 10, etc., where the user can take out water or ice.

In addition, the door 30 may be provided with a cavity 150a recessed inward to form a space for taking out water or ice, and a dispenser nozzle 152 and a dispenser lever 151 may be provided in the cavity 150a. When the user presses the dispenser lever 151, water or ice may be discharged from the dispenser nozzle 152.

The cooler 160 may supply cool air to the storage chamber 20. Particularly, the cooler 160 may make the temperature of the storage chamber 20 remain within a range set by the user by using evaporation of a refrigerant.

The cooler 160 may include a compressor 161 for compressing a gaseous refrigerant, a condenser 162 for changing the compressed gaseous refrigerant into a liquid state, an expander 163 for depressurizing the liquid refrigerant, and an evaporator 164 for changing the depressurized liquid refrigerant into a gaseous state.

The cooler 160 may cool the air in the storage chamber 20 using a phenomenon in which a liquid refrigerant absorbs thermal energy of ambient air while changing the refrigerant from liquid to gaseous state.

The cooler 160 is not, however, limited to having the compressor 161, the condenser 162, the expander 163, and the evaporator 164.

For example, the cooler 160 may include a Peltier device that uses the Peltier effect. The Peltier effect refers to an effect where when a current is applied to a contact surface between different types of metals, a heating phenomenon occurs to one metal while heat absorption phenomenon occurs to the other metal. The cooler 160 may use the Peltier device to cool the air in the storage chamber 20.

In another example, the cooler 160 may include a magnetic cooling device that uses the magneto-caloric effect. The magneto-caloric effect refers to an effect where a particular material (e.g., a magneto-caloric material) emits heat when magnetized and absorbs heat when demagnetized. The cooler 160 may use the magnetic cooling device to cool the air in the storage chamber 20.

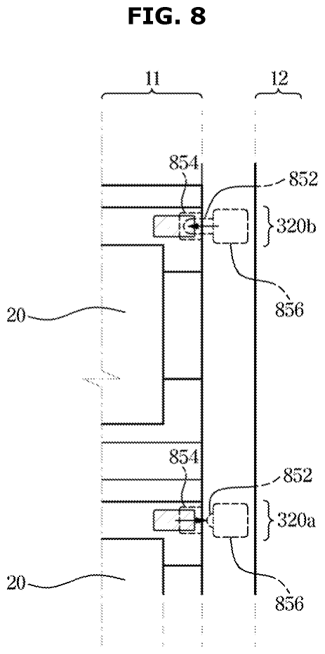

The locking device 320 of the storage chamber 20 may be provided for each storage chamber 200 to prevent the storage chamber 20 from being opened (locked) or opened (unlocked). The locking and unlocking of the locking device 320 may be controlled by a control signal of the controller 110. The controller 110 may unlock the storage chamber 20 designated to the user whose authentication has been completed, and does not unlock the storage chamber 20 designated to the user who has not completed authentication. The locking device 320 of the storage chamber 20 will be described in detail with reference to FIG. 8 to be described later.

The temperature sensor 170 may include inner temperature sensors 171 provided inside the storage chamber 20 for detecting the temperature of the inside of the storage chamber 20.

The inner temperature sensors 171 may each be installed in one of the plurality of storage chambers 20a, 20b, and 20c for detecting the temperature and output an electric signal corresponding to the detected temperature to the controller 110. Each of the inner temperature sensors 171 may include a thermistor whose electric resistance is changed by the temperature.

The audio 180 may include a speaker 181 that converts the electric signal received from the controller 110 into a sound signal and outputs the converted sound signal, and a microphone 182 that converts the sound signal into the electric signal and outputs the converted electrical signal to the controller 110.

In FIG. 3, the user authentication device 190 may include the fingerprint sensor 50, the bio-signal sensor 60, and a user authentication controller 192. The fingerprint sensor 50 and the bio-signal sensor 60 have been previously described with reference to FIG. 1. The user authentication controller 192 may perform user registration, storage chamber designation, and user authentication based on the fingerprint or a bio-signal. In other words, when the user inputs the fingerprint through the fingerprint sensor 50 or bio-signal information through the bio-signal sensor 60 (user registration) and the user selects the desired storage chamber 20, the storage chamber 20 may be designated to the user (storage chamber designation). Thereafter, when the user inputs fingerprint or biometric information to access the storage chamber 20 designated to the user, the user authentication controller 192 may allow the user to use the storage chamber 20 when the previously registered fingerprint data or biometric information data match (user authentication). When the input fingerprint or biometric information does not match the previously registered fingerprint data or biometric information data, the user authentication controller 192 does not allow the user to use the storage chamber 20.

The controller 110 may include a memory 112 for storing programs and data for controlling the operation of the refrigerator 1, and a processor 111 that generates the control signal for controlling the operation of the refrigerator 1 according to programs and data stored in the memory 112. The processor 111 and the memory 112 may be implemented as separate chips, or may be implemented as a single chip.

The memory 112 may temporarily store the user's touch input data input through the touch screen display 120, storage data stored in the storage 130, communication data received through the communicator 140, and/or temperature data detected through the temperature sensor 170. For example, the memory 112 may store the screen and/or the image to be displayed on the touch screen display 120, and store coordinates of the user's touch input through the touch screen display 120 and a control command corresponding to the user's touch input.

The memory 112 may include volatile memory, such as Static-Random Random Access Memory (S-RAM) and Dynamic-Random Access Memory (D-RAM), for temporarily storing data. Also, the memory 112 may include non-volatile memory, such as Read Only Memory (ROM), Erasable Programmable Read Only Memory (EPROM), and Electrically Erasable Programmable Read Only Memory (EEPROM), for storing data for a long period of time.

The processor 111 may include various logic circuits and operation circuits, and process data according to a program provided from the memory 112, and generate a control signal according to the result of the processing.

For example, the processor 111 may process the touch input inputted through the touch screen display 120 and determine the user's control command according to the coordinates of the touch input. In addition, the processor 111 may control the communicator 140 to obtain information corresponding to the user's control command, and control the touch screen display 120 to display the screen and/or the image corresponding to the user's control command.

The processor 111 may process input data input through the touch screen display 120 and transmit the input data to the external device through the communicator 140. In addition, the communication data received through the communicator 140 may be processed, and the image based on the communication data may be displayed on the touch screen display 120.

As such, the controller 110 may control the operation of the refrigerator 1 according to the user input received through the touch screen display 120 and/or programs and data stored in the storage 130.

Although the touch screen display 120, the storage 130, the communicator 140, the dispenser 150, the cooler 160, the temperature sensor 170, the audio 180, and the controller 110 included in the refrigerator 1 have been described above, new components may be added or some components may be omitted if necessary.

FIG. 4 is a view illustrating an example in which a refrigerator communicates with external devices according to an embodiment. As illustrated in FIG. 4, the refrigerator 1 may communicate with various external electronic devices through the communicator 140.

For example, as illustrated in FIG. 4, the refrigerator 1 may connect to a wireless access point (AP) through the communicator 140. Particularly, the refrigerator 1 may connect to an access repeater using a wireless communication standard such as Wi-Fi™ (IEEE 802.11), Bluetooth™ (IEEE 802.15.1), or Zigbee (IEEE 802.15.4).

The AP may be called in various ways such as “hub”, “router”, “switch”, and “gateway”, and may be connected to a wide area network (WAN) such as an Internet.

Various home appliances such as an air conditioner, a washing machine, an electric oven, a microwave oven, a robot cleaner, a security camera, a lamp, and a television may be connected to the AP, as well as the refrigerator 1. In addition, the home appliances connected to the AP may form a local area network (LAN).

In addition, the AP may connect the LAN formed by the home appliances connected to the AP and the WAN such as the Internet. A service server 3 providing a predetermined service to the refrigerator 1 and user devices 2 (2a and 2b) may be connected to the WAN.

The service server 3 may provide various services to the refrigerator 1. For example, the service server 3 may manage account information of the user of the refrigerator 1 and store photos, videos, memos, schedules, sketches, etc. input by the user of the refrigerator 1. In addition, the service server 3 may search for food recipes according to a request of the refrigerator 1, provide the recipes to the refrigerator 1, and transmit a shopping list to be purchased online to an online shopping mall server.

Also, the service server 3 may transmit photos, videos, memos, schedules, sketches, recipes, shopping lists, etc. received from the refrigerator 1 to the user devices 2 (2a and 2b).

The user devices 2 (2a and 2b) may access the WAN through a mobile communication service provided by a mobile communication service provider, or access the WAN through the AP. The user devices 2 (2a and 2b) may connect to the WAN wirelessly or wired, and communicate with other devices such as the refrigerator 1. The user devices 2 (2a and 2b) may be portable devices that the user can carry and move, or may be fixed devices that are difficult to move. For example, the user devices 2 (2a and 2b) may be variously called mobile devices, cell phones, cellular phones, smart phones, personal communication services (PCS), personal digital assistants (PDAs), computers, notebook computers, personal computers (PCs), a laptop, a desktop, and the like.

The refrigerator 1 may perform the user registration, the storage chamber designation, and the user authentication through communication with the external devices. For example, the user may input unique information and designate the storage chamber 20 using the external device that he or she has, for example, the user device 2 such as a mobile device. The user who has completed user registration and storage chamber designation may go through a user authentication process through the user device 2.

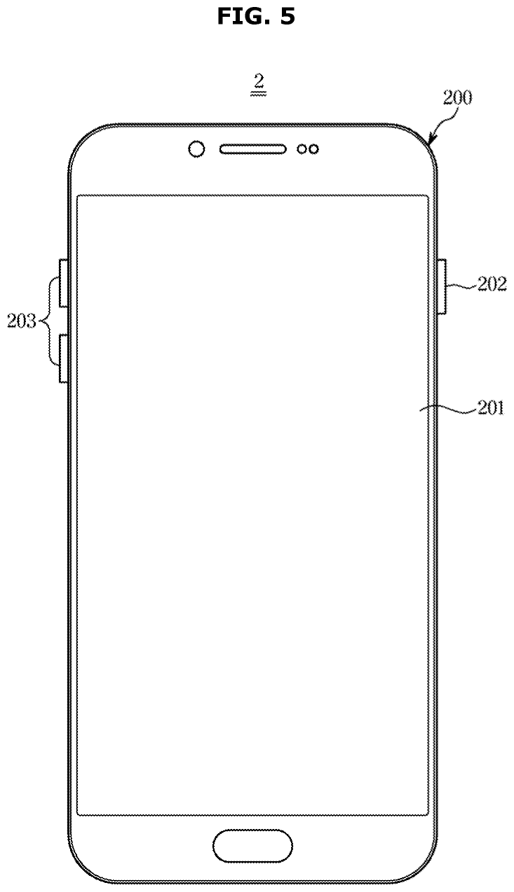

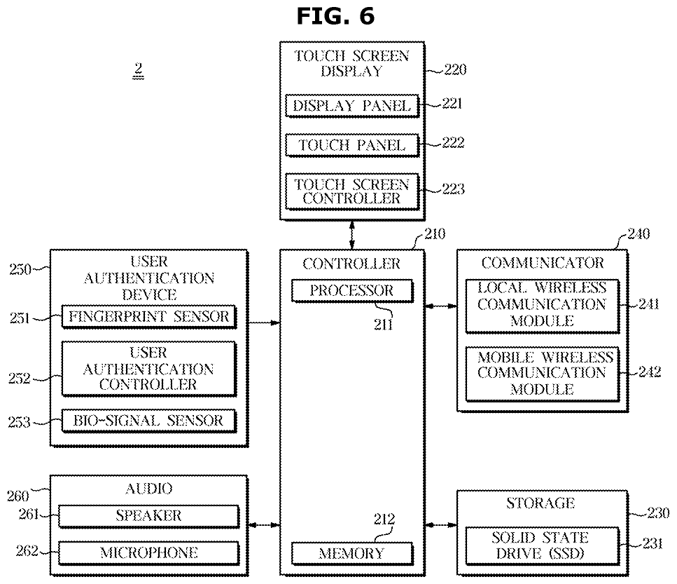

FIG. 5 is a view illustrating an appearance of a user device communicating with a refrigerator according to an embodiment. FIG. 6 is a view illustrating a control system of the user device illustrated in FIG. 5. The configuration and operation of the user devices 2 (2a and 2b) will be described with reference to FIGS. 5 and 6.

The user device 2 includes a box-shaped body 200, a screen 201 provided on the front of the body 200, and input buttons 202, 203, and 204 provided on the front or side of the body 200.

The body 200 may form an exterior of the user device 2, and may accommodate and protect various components included in the user device 2 to be described below.

The screen 201 may receive the user input and display the image according to the user input.

The input buttons 202, 203, and 204 may receive a predetermined command from the user. For example, the input buttons 202, 203, and 204 may include the power button 202 for powering on/off the user device 2, and the volume control button 203 for adjusting a volume of sound output from the user device 2, and a home button 204 for changing the image displayed on the screen 201 of the user device 2 into a home screen.

In addition, the user device 2 may include a touch screen display 220, a storage 230, a communicator 240, a user authentication device 250, an audio 260, and a controller 210.

The touch screen display 220 may form the screen 201 of the body 200. In addition, the touch screen display 220 may include a display panel 221 that displays the image, a touch panel 222 that receives the touch input, and a touch screen controller 223 that drives/controls the display panel 221 and the touch panel 222.

The display panel 221, the touch panel 222, and the touch screen controller 223 differ in size and a installation position from the display panel 121, the touch panel 122, and the touch screen controller 123 described in FIGS. 3 and 4, but may have the same function.

The storage 230 may include a non-volatile memory that stores a program or power and does not lose the stored program or data even when the power is cut off. For example, the storage 230 may include a large-capacity flash memory or a Solid State Drive (SSD) 231.

The storage 230 may store control programs and control data for controlling the operations of the refrigerator 1 and various application programs and application data that perform various functions according to the user input. For example, the storage 230 may store the OS program, the album application, a memo application, a sketch application, a scheduler application, an online shopping application, a shopping list application, a view inside application, and the like.

The storage 230 may provide programs and data to the controller 210 according to a storage control signal from the controller 210 or may store data output from the controller 210.

The communicator 240 may exchange data with the external device according to a communication control signal of the controller 210. For example, the communicator 240 may include a local wireless communication module 241 and a mobile wireless communication module 242 that wirelessly transmit communication data to the external device and wirelessly receive communication data from the external device.

The local wireless communication module 241 may wirelessly exchange data with the external device located at a relatively close distance. The local wireless communication module 241 may communicate with the external device using, for example, a communication standard such as Wireless Fidelity (WiFi), Bluetooth, and Zigbee.

The mobile wireless communication module 242 may wirelessly exchange data with a base station, and may access the WAN through the base station or communicate with the external device through the base station. The mobile wireless communication module 242 may communicate using a communication standard such as Time Division Multiple Access (TDMA), Code Division Multiple Access (CDMA), and Wide Code Division Multiple Access (WCDMA), Code Division Multiple Access (CDMA) 2000, Wireless Broadband (Wibro), World Interoperability for Microwave Access (WiMAX), Long Term Evolution (LTE) and/or Wireless Broadband Evolution Communication.

The local wireless communication module 241 and mobile wireless communication module 242 may each include the antenna for transmitting a wireless signal to the free space or receiving the wireless signal from the free space, a modulator/demodulator for modulating data to be transmitted or demodulating the received wireless signal.

In FIG. 6, the user authentication device 250 may include a fingerprint sensor 251, a bio-signal sensor 253, and a user authentication controller 252. The fingerprint sensor 251 may be for scanning the fingerprint of the user's thumb, but may scan the fingerprint of the remaining four fingers excluding the thumb. The bio-signal sensor 253 may be for measuring the user's bio-signal including at least one of blood pressure, blood flow, heart rate, body temperature, body fat percentage, and weight. The user authentication controller 252 may perform user registration, storage chamber designation, and user authentication based on the fingerprint or a bio-signal. In other words, when the user inputs the fingerprint through the fingerprint sensor 251 or bio-signal information through the bio-signal sensor 253 and the user selects the desired storage chamber 20, the storage chamber 20 may be designated to the user. Thereafter, when the user inputs fingerprint or biometric information to access the storage chamber 20 designated to the user, the user authentication controller 252 may allow the user to use the storage chamber 20 when the fingerprint data or the biometric information data already registered in the user device 2, the service server 3, or the refrigerator 1 match. When the input fingerprint or biometric information does not match the previously registered fingerprint data or biometric information data, the user authentication controller 252 does not allow the user to use the storage chamber 20.

The audio 260 may include a speaker 261 that converts the electric signal received from the controller 210 into the sound signal and outputs the converted sound signal, and a microphone 262 that converts the sound signal into the electric signal and outputs the converted electrical signal to the controller 210.

The controller 210 may include a memory 212 for storing programs and data for controlling the operation of the user device 2, and a processor 211 that generates the control signal for controlling the operation of the refrigerator 1 according to programs and data stored in the memory 212. The processor 211 and the memory 212 may be implemented as separate chips, or may be implemented as a single chip.

The memory 212 may temporarily store the user's touch input data input through the touch screen display 220, storage data stored in the storage 230, and communication data received through the communicator 240.

The memory 212 may include volatile memory, such as S-RAM and D-RAM, for temporarily storing data. Also, the memory 212 may include non-volatile memory, such as ROM, EPROM, and EEPROM, for storing data for a long period of time.

The processor 211 may include various logic circuits and operation circuits, and process data according to a program provided from the memory 212, and generate a control signal according to the result of the processing.

For example, the processor 211 may process the touch input inputted through the touch screen display 220 and control the touch screen display 220 to display the screen and/or the image when the touch input is input. Also, when the touch input is input, the processor 211 may transmit data to the external device through the communicator 240 or may receive data from the external device.

As such, the controller 210 may control the operation of the refrigerator 1 according to the user input received through the touch screen display 220 and/or programs and data stored in the storage 230.

The operation of the user device 2 described below can be viewed as being controlled by the controller 210.

Although the touch screen display 220, the storage 230, the communicator 240, the user authentication device 250, the audio 260 and the controller 210 included in the user device 2 have been described above, new configurations may be added or some configurations may be omitted if necessary.

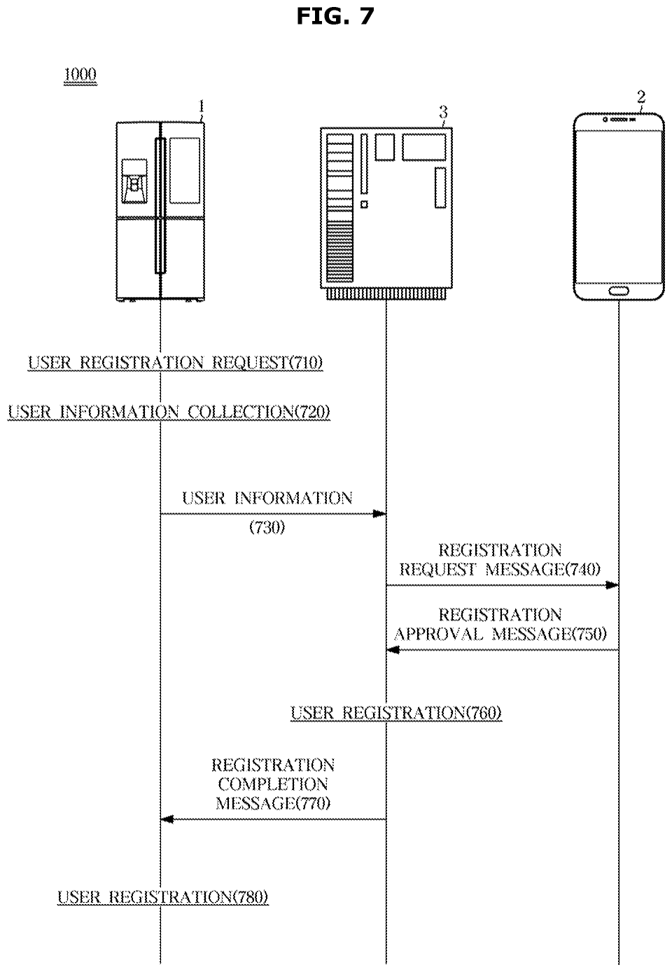

FIG. 7 is a view illustrating user registration of a refrigerator according to an embodiment. FIG. 7 is a view illustrating user registration through the user device 2 and the service server 3 in particular.

The refrigerator 1 may be used by the plurality of users. For example, when the refrigerator 1 is installed in a home, all family members may use the refrigerator 1. Accordingly, the refrigerator 1 may register several people (e.g., family members) as users.

The user device 2 and the service server 3 do not intervene, and the refrigerator 1 may register the user, designate the storage chamber, and perform user authentication. In other words, when the user inputs the fingerprint through the fingerprint sensor 50 or bio-signal information through the bio-signal sensor 60 (user registration) and the user selects the desired storage chamber 20, the storage chamber 20 may be designated to the user (storage chamber designation). Thereafter, when the user inputs fingerprint or biometric information to access the storage chamber 20 designated to the user, the user authentication controller 192 may allow the user to use the storage chamber 20 when the previously registered fingerprint data or biometric information data match (user authentication).

Alternatively, as illustrated in FIG. 7, the refrigerator 1, the user device 2, and the service server 3 may cooperate to perform the user registration. Depending on the embodiment, the users may all belong to the same class or may be classified into different classes. For example, the users may be classified into a main user and sub users. The main user may represent users of the refrigerator 1 and may use most functions of the refrigerator 1. Also, in order to register the refrigerator 1 with the service server 3, an account of the main user may be registered with the service server 3. The sub users may use various functions of the refrigerator 1 together with the main user. In addition, accounts of each of the sub users may be registered in the service server 3 as the sub users.

The refrigerator 1 may determine whether the user is registered (710). The refrigerator 1 may determine whether the user is registered according to a user's touch input through the touch screen display 120.

The users (main user and/or sub users) may execute a refrigerator setting application to register a new user (sub users). In addition, the user may select a user registration menu from the screen displayed on the touch screen display 120 by the refrigerator setting application. When the user registration menu is selected, the refrigerator 1 may determine the registration of the user.

When registering the user, the refrigerator 1 may collect user information of the new user (720).

The refrigerator 1 may collect the user information of the new user through the touch screen display 120. The user information may include information such as a name, account, password, phone number, e-mail address, etc. for verifying the user's identity. Also, the user information may include fingerprint or biometric information. In addition, the user information may include information for selecting the storage chamber 20 desired by the user. The storage chamber 20 may be arbitrarily allocated by the controller 110 of the refrigerator 1 without user selection.

The refrigerator 1 that has collected the user information of the user may transmit the user information to the service server 3 through the communicator 140 (730).

The service server 3 receiving the user information may transmit a registration request message to the user device 2 to identify the user registration (740). In order to identify the user information received from the refrigerator 1 and prevent theft of the user account, the service server 3 may transmit the registration request message to the user device 2 to identify the user registration.

For example, the service server 3 may transmit a text message (SMS message) to the user device 2 based on the phone number included in the user information. The text message may display a message indicating that the user registration has been requested through the refrigerator 1, and may request input of an authentication code for authenticating the user.

As another example, the service server 3 may transmit an e-mail to the user device 2 based on an e-mail address included in user information. The e-mail may display a message indicating that the user registration has been requested through the refrigerator 1, and may request input of the authentication code for authenticating the user.

The user may identify a user registration message (text message and/or e-mail) received on the user device 2 and input the authentication code. The authentication code may be a password of the user account determined in advance, or a One Time Password (OTP) randomly generated by the service server 3 and transmitted to the user device 2 and the refrigerator 1.

The user device 2 may transmit a registration approval message for approving the registration of a new account of the refrigerator 1 to the service server 3 (750).

When the authentication code is input, the user device 2 may transmit the authentication code to the service server 3, and the service server 3 may determine whether the authentication code input by the user matches the previously stored/generated authentication code. When the authentication code input by the user matches the previously stored/generated authentication code, the user authentication may be completed.

When the user authentication by the authentication code is completed, the user device 2 may transmit the registration approval message for approving a new account registration of the refrigerator 1 to the service server 3 through the communicator 240.

The user authentication operations 740 and 750 by the user device 2 described above may be optional operations. For example, when the user enters the email address and the phone number into the refrigerator 1, the user authentication operations 740 and 750 may be performed. When the user does not enter the email address and the phone number into the refrigerator 1, the user authentication operations 740 and 750 may not be performed.

Upon receiving the registration approval message, the service server 3 may register a new user (760).

The service server 3 may register the new user based on the user information received from the refrigerator 1 and designate the storage chamber 20 to be used by the user. For example, the service server 3 may additionally store the user information of the new user in the user list of the refrigerator 1. In addition, when the user does not input the email address and the phone number into the refrigerator 1, the service server 3 may register the new user when the user information is received from the refrigerator 1.

Thereafter, the service server 3 may transmit a registration completion message indicating completion of user registration to the refrigerator 1 (770).

When the registration completion message is received from the service server 3, the refrigerator 1 may register the new user (780).

The refrigerator 1 may register the new user based on the user information input through the touch screen display 120. For example, the refrigerator 1 may additionally store the user information of the new user in the user list.

As described above, the refrigerator 1 may collect the user information of the new user and register the new user as the user of the refrigerator 1 based on the collected user information. Particularly, the refrigerator 1 may store the user information of the new user in the user list.

FIG. 8 is a view illustrating a locking device of a storage chamber of a refrigerator according to an embodiment. The refrigerator 1 may include a locking device 320 for each storage chamber 20 to allow access to each storage chamber 20 only to the designated user. The locking device 320 of each storage chamber 20 may unlock the storage chamber 20 only when the designated user authenticates, thereby excluding other users' access and allowing only the designated user to use the storage chamber 20.

As illustrated in FIG. 8, the locking device 320 of the refrigerator 1 may include a locking member 852, a latching member 854, and a driver 856.

The locking member 852 is in an unlocked state when located in a space between the inner case 11 and the outer case 12 of the main body 10 of the refrigerator 1 as illustrated in 320a. In the state, the storage chamber 20 may be opened. When the locking member 852 is deployed and inserted into the latching member 854 provided on one side of the storage chamber 20, the storage chamber 20 is in a locked state 320b. In the state, the storage chamber 20 cannot be opened due to an interaction of the locking member 852 and the latching member 854.

The locking and unlocking of the locking member 852 may be implemented by a driving force of the driver 856. The driver 856 may be connected to communicate with the controller 110 and receive the control signal related to locking and unlocking from the controller 110. The driver 856 may generate the driving force in response to the control signal generated from the controller 110 to deploy (320b) or return the locking member 852 (320a) to implement locking and unlocking of the storage chamber 20. The driver 856 may be a solenoid valve for driving the locking member 852. The locking member 852 may be made of a plastic material as well as a metal material.

The latching member 854 may be a groove or a through hole provided on the side of the storage chamber 20. The latching member 854 may be formed to have an inner space capable of sufficiently receiving the locking member 852 when the locking member 852 is in the state of 320b.

The locking device 320 of the storage chamber 20 is not limited to a structure illustrated in FIG. 8, and other types of locking devices capable of preventing unauthorized use of the storage chamber 20 may be used.

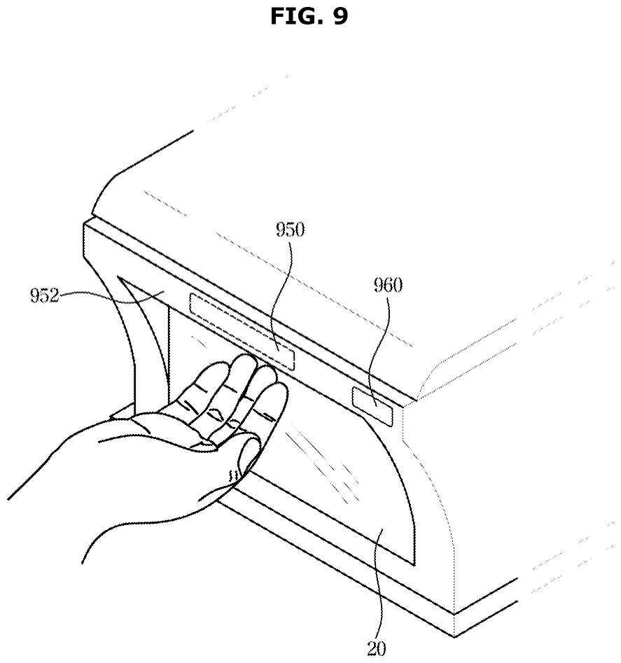

FIG. 9 is a view illustrating another embodiment of a user authentication device of a refrigerator according to an embodiment.

As illustrated in FIG. 9, another type of user authentication device 950 may be provided on an inner surface of a handle 952 of the storage chamber 20. That is, when the user grips the handle 952 of the storage chamber 20 to open the storage chamber 20, the user authentication device 950 may be formed where the fingers are located. Accordingly, when the user holds the handle 952 of the storage chamber 20, the user's finger may naturally contact the user authentication device 950. The user authentication device 950 may include the fingerprint sensor or the bio-signal sensor.

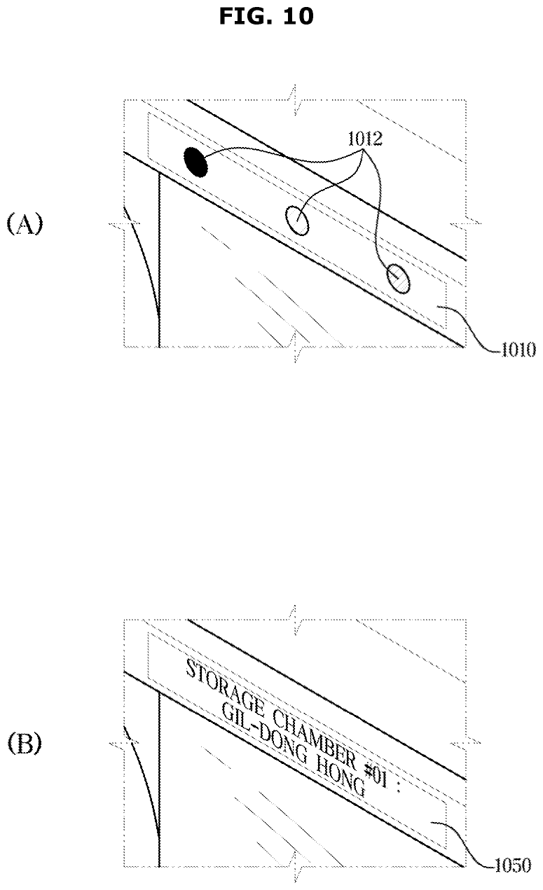

In FIG. 9, reference numeral 960 denotes a display. The display 960 may be provided to display information of the designated user of the storage chamber 20 and the like. The display of the user information will be described in detail with reference to FIG. 10 to be described later.

FIG. 10 is a view illustrating an example of a display provided in a storage chamber of a refrigerator according to an embodiment. A display 1010 of

FIG. 10A may be implemented with the LED, and a display 1050 of FIG. 10B may be implemented with the LCD.

The display 1010 illustrated in FIG. 10A may include a plurality of LEDs 1012. The plurality of LEDs 1012 may be lit in a predetermined color to express a message of a predetermined content. For example, when only one of the plurality of LEDs 1012 is lit with the predetermined color, this may indicate that the storage chamber 20 is designated to a specific user. To this end, a unique color may be set for each family member, and the LED 1012 may be turned on with the unique color for each family member designated for each storage chamber 20.

Similarly, some or all of the plurality of LEDs 1012 are each lit with the predetermined color to express a certain color combination, thereby indicating that the storage chamber 20 is designated to a predetermined specific user.

In addition, in the case of the storage chamber having the user authentication device 950 of FIG. 9 described above, when an undesignated user grips the handle 952 to open the specific storage chamber 20, the controller 110 may warn that a current user is not the user designated to the storage chamber 20 by causing at least one of the plurality of LEDs 1012 of FIG. 10 to blink red.

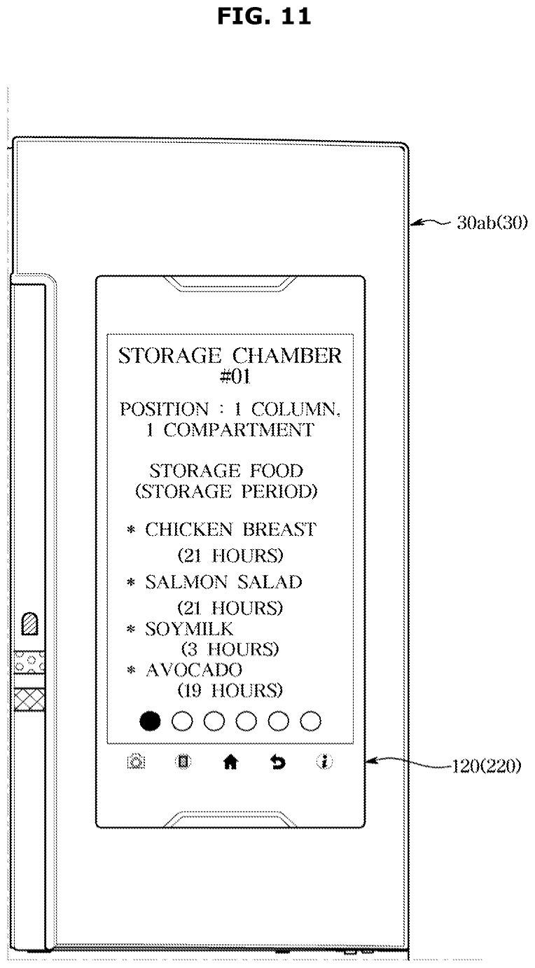

FIG. 11 is a view illustrating an example of displaying storage chamber information of a refrigerator according to an embodiment. In the embodiment of FIG. 11, after the user authentication, a position of the designated storage chamber (for example, storage chamber #1) 20, a list of foods currently being stored, and a storage period are displayed through the touch screen displays 120 and 220.

As illustrated in FIG. 11, when the user authentication is completed, information on the storage chamber 20 designated to the user may be displayed through the touch screen display 120. In a case of FIG. 11, the position of the <storage chamber #1> may be displayed ‘1 column, 1 compartment’ through the touch screen display 120. The food and storage period stored in the <storage chamber #1> are ‘chicken breast (21 hours)’ and ‘salmon salad (21 hours)’, ‘soy milk (3 hours)’, and ‘avocado (19 hours)’ may be displayed through the touch screen display 120. The user may easily and conveniently identify the position of the storage chamber 20 and the food list designated to the user with the user authentication.

The information about the storage chamber 20 as illustrated in FIG. 11 may be displayed not only through the touch screen display 120 of the refrigerator 1 but also through the touch screen display 220 of the user device 2 communicating with the refrigerator 1.

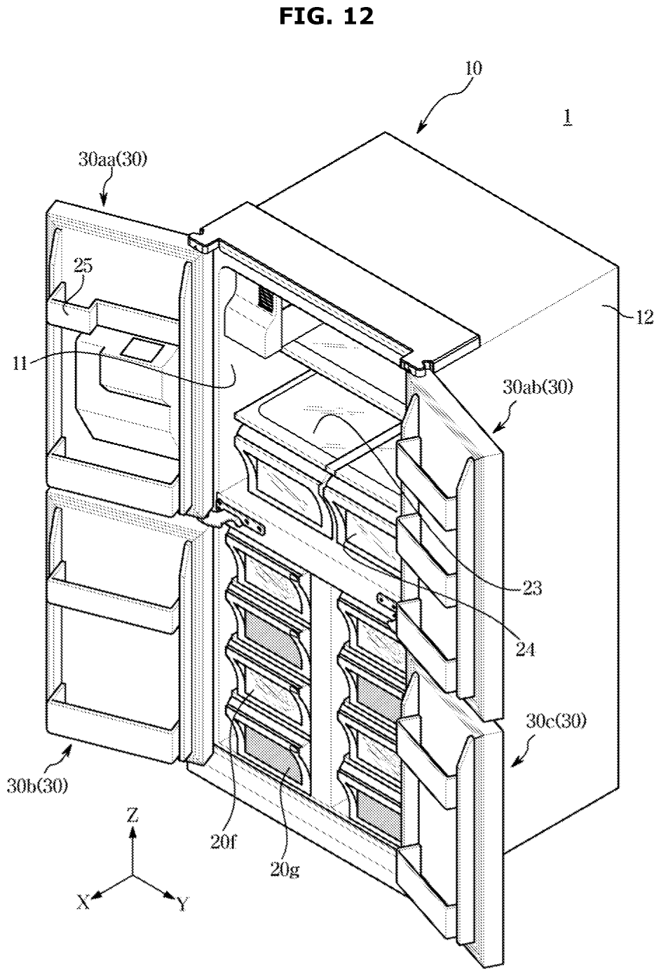

FIG. 12 is a view illustrating another example of a storage chamber of a refrigerator according to an embodiment. The refrigerator 1 may designate the user for each storage chamber 20 and protect the privacy of the user who uses the storage chamber 20 by limiting the use of the storage chamber 20 except for the designated user. To this end, the refrigerator 1 illustrated in FIG. 12 may employ a variable glass on the front of each storage chamber 20, and control the front surface of the storage chamber 20 to be transparent or opaque if necessary, so that the contents of items stored in each storage chamber 20 are not known form the outside.

In FIG. 12, the storage chamber 20 may be divided into a storage chamber 20f having a transparent front surface and a storage chamber 20g having an opaque front surface. When the door 30 of the refrigerator 1 is opened, the storage chamber 20f having the transparent front surface can see the items inside the storage chamber 20f. In contrast, when the door 30 of the refrigerator 1 is opened, the storage chamber 20g in which the front surface is in an opaque state cannot see the items inside the storage chamber 20g.

In the refrigerator 1, the front of all storage chambers 20 is basically maintained in the opaque state. When the user authentication of the specific user is completed, only the storage chamber 20 designated for the user is changed transparent like the storage chamber 20f so that the user can see the inside of the storage chamber 20 designated to the user. In this case, the storage chamber 20 not designated to the user maintains the opaque state like the storage chamber 20g so that the contents cannot be viewed by a non-designated user.

For this purpose, the front of the storage chamber 20 may be made of variable glass. The variable glass is a laminated glass in which a variable film having a variable transmittance is inserted between two or more sheets of glass, and the transmittance of the variable film may be varied by adjusting a size of an electric signal applied to the variable film. By varying the transmittance in this way, the variable glass may be converted into the transparent state or the opaque state.

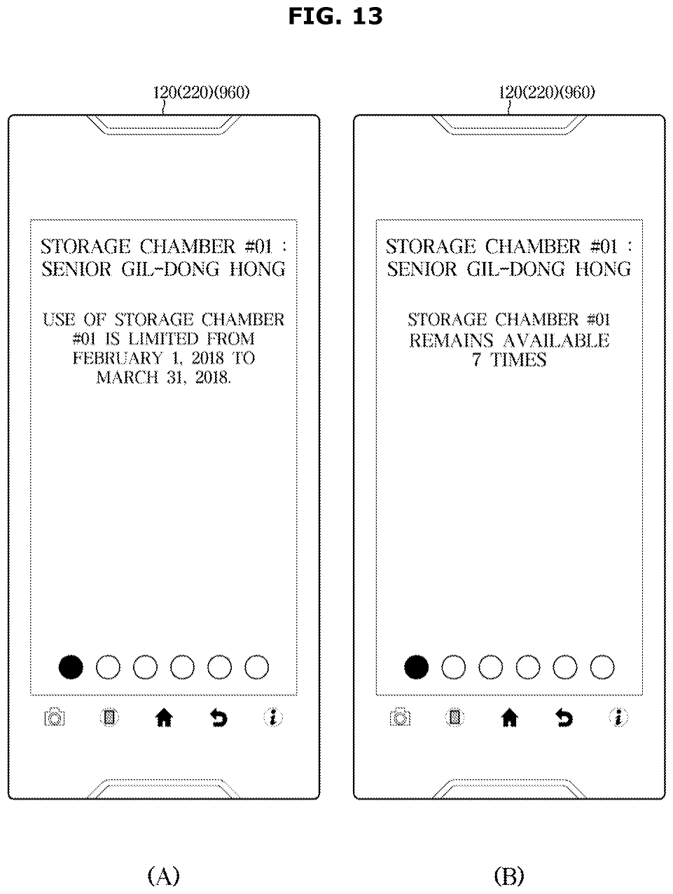

FIG. 13 is a view illustrating another example of displaying storage chamber information according to user authentication of a refrigerator according to an embodiment. In the embodiment of FIG. 13, access restriction information of a designated storage chamber (for example, storage chamber #1) 20 after the user authentication may be displayed through the touch screen displays 120 and 220.

As illustrated in FIG. 13, when the user authentication is completed, the information about the storage chamber 20 designated to the user may be displayed through the touch screen display 120. FIG. 13A illustrates a case that storage chamber #1 designated to user ‘Senior Gil-dong Hong’ is limited from Feb. 1, 2018 to Mar. 31, 2018. FIG. 13B illustrates a case in which the number of times the number of access allowed to the user ‘Senior Hong Gil-dong’ of storage chamber #1 remains 7 times. The user may easily and conveniently identify an access restriction period or the number of times of access of the storage chamber 20 designated to the user along with user authentication.

The information about the storage chamber 20 as illustrated in FIG. 13 may be displayed not only through the touch screen display 120 of the refrigerator 1 but also the touch screen display 220 of the user device 2 that communicates with the refrigerator 1. Alternatively, as illustrated in FIG. 9 described above, the access restriction period or the number of times the storage chamber 20 can be accessed may be displayed through the display 960 provided for each storage chamber 20.

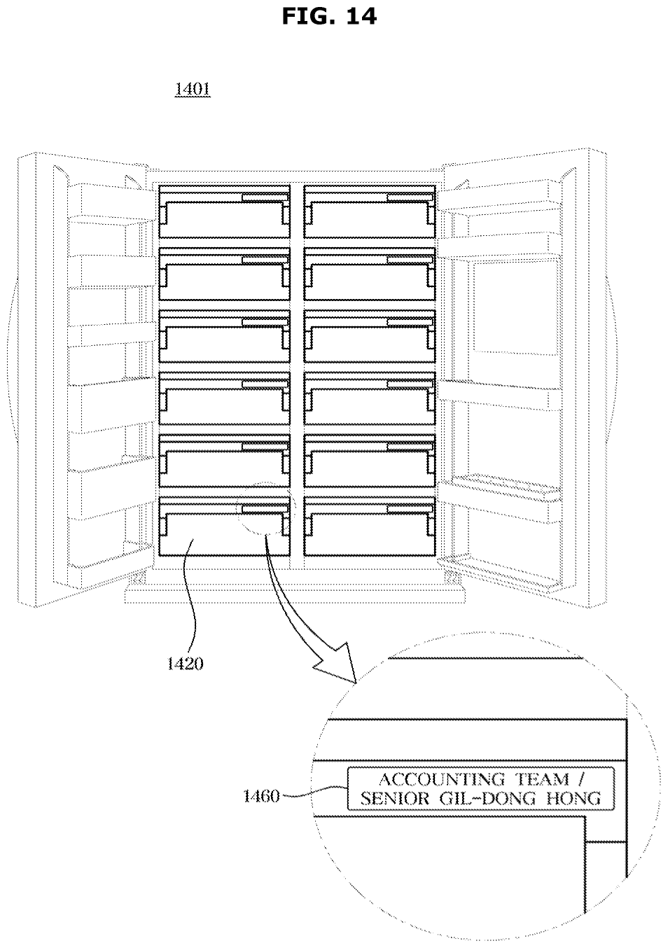

FIG. 14 is a view illustrating a refrigerator according to another embodiment. FIG. 14 is a view illustrating a refrigerator 1401 commonly used by the plurality of users.

As illustrated in FIG. 14, a refrigerator 1401 may be provided with a plurality of storage chambers 1420 of relatively uniform standards. The refrigerator 1401 illustrated in FIG. 14 is shared by the plurality of users in schools, workplaces, and dormitories, it is more preferable to have the plurality of storage chambers 1420 of relatively uniform standards instead of various types of storage chambers such as a vegetable storage room, a meat storage room, and a kimchi storage room of a home refrigerator.

In addition, the user is designated for each storage chamber 1420 so that each of the plurality of users can individually use the storage chamber 1420 designated for the corresponding user through user approval.

In addition, by providing a display 1460 for each storage chamber 1420, and displaying information about the designated user of each storage chamber 1420 is displayed on the display 1460, the user may distinguish the storage chamber 1420 designated by the user. For example, as illustrated in FIG. 14, a user's affiliation, name, and position may be displayed on the display 1460. The content displayed on the display 1460 is not limited to the user's affiliation, name, and position, and may be user-specific information capable of identifying each user.

As mentioned in the various embodiments described above, the storage chamber 1420 of the refrigerator 1401 of FIG. 14 may also be accessed only by the designated (registered) user through the user authentication.

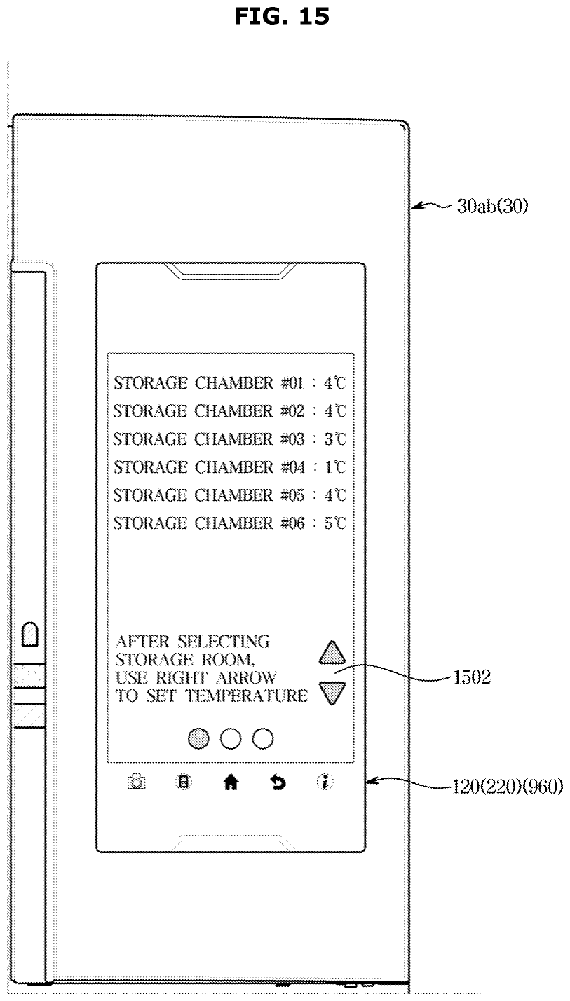

FIG. 15 is a view illustrating another example of displaying storage chamber information of a refrigerator according to an embodiment. In the embodiment of FIG. 15, by displaying each set temperature of the storage chamber 20 provided in the refrigerator 1, the user may identify the set temperature of the storage chamber 20 designated to the user. When the designated user of storage chamber #4 identifies that the set temperature of his designated storage chamber #4 is 1° C. after user authentication and thinks that the set temperature is too low, the user may select the storage chamber #4 by touching the storage chamber #4 part and change the set temperature to a target set temperature by touching an arrow icon 1502.

The disclosed embodiments are merely illustrative of the technical idea. Those having ordinary skill in the art should appreciate that various modifications, changes, and substitutions may be made without departing from the essential characteristics thereof. Therefore, the embodiments disclosed above, and the accompanying drawings, are not intended to limit the technical idea, but to describe the technical spirit of the disclosure. The scope of the technical idea is not limited by the embodiments and the accompanying drawings. The scope of protection shall be interpreted by the following claims, and all technical ideas within the scope of equivalent shall be interpreted as being included in the scope of rights.

1. A refrigerator comprising:
a display;
a storage chamber configured to allow use only by authorized users; and
a controller configured to display information of the storage chamber through the display in response to the completion of user authentication of the storage chamber.

2. The refrigerator according to claim 1, wherein the display is provided in the storage chamber.

3. The refrigerator according to claim 2, wherein the display comprises a plurality of Light Emitting Diodes (LEDs), and is configured to display information of the storage chamber through lighting of the plurality of LEDs.

4. The refrigerator according to claim 3, wherein the information of the storage chamber is configured to distinguish the designated user by lighting the plurality of LEDs in a combination of a plurality of colors.

5. The refrigerator according to claim 2, wherein the display comprises at least one liquid crystal display (LCD) device, and is configured to display information of the storage chamber through the at least one LCD device.

6. The refrigerator according to claim 5, wherein the information of the storage chamber comprises a limit period of use of the storage chamber.

7. The refrigerator according to claim 5, wherein the information of the storage chamber comprises the number of times the storage chamber can be used.

8. The refrigerator according to claim 1, further comprising:
a door provided to open and close the storage chamber,
wherein the display is provided on the door.

9. The refrigerator according to claim 8, wherein the information of the storage chamber displayed on the display comprises position information of the storage chamber and storage item information of the storage chamber.

10. The refrigerator according to claim 8, wherein the information of the storage chamber displayed on the display comprises a set temperature of the storage chamber.

11. The refrigerator according to claim 10, wherein a user interface for allowing an authenticated user to change the set temperature of the storage chamber is configured to display on the display.

12. The refrigerator according to claim 1, wherein a surface exposed to the outside of the storage chamber is formed of variable transmittance glass.

13. The refrigerator according to claim 12, wherein, by adjusting the transmittance of the variable transmittance glass, only the authorized user of the storage chamber may see the inside of the storage chamber.

14. The refrigerator according to claim 1, wherein:
the storage chamber is composed of a plurality of storage chambers;
the display is provided in each of the plurality of storage chambers; and
the display of each of the plurality of storage chambers is configured to display user information of each of the plurality of storage chambers.

15. The refrigerator according to claim 14, wherein the user information comprises at least one of a name of the user designated to each of the plurality of storage chambers and a name of a user group.
